(19) United States
(12) Patent Application Publication
(10) Pub. No.: US 2003/0014484 A1
(43) Pub. Date: Jan. 16, 2003

(54) Scheduling in a remote-access server

(76) Inventors: Arnon Netzer, Givat-Ella (IL); Reuven Moshkovich, Carmiel (IL); Gil Graiber, Kfar-Vradim (IL)

Correspondence Address: William H Dippert, Reed Smith, 599 Lexington Avenue, New York, NY, 10022-7650, US

(21) Appl. No.: 10/203,304

(22) PCT Filed: Feb. 8, 2001
(86) PCT No.: PCT/IL01/00132

(30) Foreign Application Priority Data
Nov. 9, 2000 PCT/IL00/00733

(51) Int. Cl. G06F 15/16

(52) U.S. Cl. 709/203

(57) ABSTRACT

A method of scheduling the handling of data from a plurality of channels. The method includes accumulating data from a plurality of channels by a remote access server, scheduling a processor of the server to handle the accumulated data from at least one first one of the channels, once during a first cycle time, and scheduling the processor to handle the accumulated data from at least one second one of the channels, once during a second cycle time, different from the first cycle time.

### FIELD OF THE INVENTION

The present invention relates to communication systems and in particular to systems for handling remote access connections.

### BACKGROUND OF THE INVENTION

Many providers of communication services employ one or more communication servers, such as remote access servers, access routers, and voice over IP gateways. The communication servers may act as modems, Fax handlers, voice over Internet Protocol (VoIP) servers and/or may provide any other communication services.

Some communication servers are multi-channel servers that have a capacity to concurrently handle a plurality of connections up to a predetermined maximal number. In addition, some communication servers, which are implemented mainly in software, for example, the servers of 3Com, Ascend, Access, ADI, Connexent, Telogy, and Hothaus, can concurrently handle different types of connections. Software based remote-access servers are generally implemented using a single processor, generally a signal processing processor such as a DSP, which is cheaper than a general purpose processor and is more suited for signal processing.

A multi-channel server, using a single processor, generally includes a scheduler that determines which channel is handled by the processor at any specific time. Usually, the channels are organized in a specific order and the processor, periodically, according to a scheduling cycle, provides a processing session to each of the channels in the specific order.

Different connections require processing time, i.e., handling of their received data, at different cycle times. For example, the ITU standard G723.1 connection requires handling of its data with a cycle of 30 milliseconds while the ITU standard G729A connection requires handling of its data with a 10 millisecond cycle. Some connections, e.g., modem and Fax connections, may operate over a large range of data rates and cycle times. All the channels must have their data processed during each cycle of their cycle time. A state in which a connection is not handled during one of its cycles is referred to as a starvation state. A connection which reaches a starvation state suffers from a degradation of service and may be disconnected.

At the end of each processing cycle, an output driver takes the processed data from a predetermined memory area, which serves as an output buffer, and forwards it to its destination. In addition, at the beginning of each processing cycle, an input driver brings raw data (i.e., data not yet processed) to a predetermined memory area, from which the processor retrieves the data for processing. Generally, there is no mechanism that prevents the output driver from retrieving old data, except the timing of the processor and the output driver. That is, if the processor requires time beyond the end of a cycle in order to finish the handling of one or more channels the output driver is not delayed but takes the data from the output buffer as usual, including old data.

Some communication servers execute, on the processor, an operating system that performs preemption. In such servers the scheduling of the processor to handle data from connections with different cycles may be lenient as the processor may interrupt the processing of data from one channel to handle data from another channel. Preemption, however, may require large percentages of the resources of the processor and therefore is wasteful.

Other communication servers limit themselves to connections which are processed with a single cycle time. Sometimes such servers are included in an array of servers each of which handles a different type of connections.

When a plurality of connections, which require handling of their data at different cycle times, are handled by the same server, the scheduler of the server chooses a longest scheduling cycle size of all the cycle times of the connections. Connections that require shorter cycle times are handled a plurality of times during each longest cycle rather than once during each of their own cycles. This, however, may involve degradation of the signals provided by the server for those connections, for example increasing their delay beyond allowed limits.

### SUMMARY OF THE INVENTION

An aspect of some embodiments of the present invention relates to a communication server which schedules processing sessions to different connections according to different scheduling schemes. In some embodiments of the present invention, different connections handled by the server receive processing sessions at different scheduling cycles. Optionally, in normal operation conditions, the processor performs actual data processing of the data of the connections in substantially all the respective processing sessions of the connections.

In some embodiments of the invention, a scheduler manages, for each connection, a record, which states the scheduling cycle of the connection, the processing time required to handle the connection, the previous time at which the connection was handled and/or the next time up to which the connection is to be handled. Each time a connection is to be selected for handling, the scheduler selects, based on the connection records, a connection which is closest to the end of its respective scheduling cycle. Alternatively or additionally, other factors, such as quality of service (QoS) rankings of the connections and/or long term fairness measures are taken into consideration in determining which connection is to receive a processing session. For example, when a few connections have the same time remaining to the end of their processing cycles, precedence may be given based on QoS and/or scheduling history.

In some exemplary embodiments of the invention, the scheduler allots processing sessions to connections according to two scheduling cycles: a short cycle and a long cycle. In some embodiments of the present invention, a long cycle time of connections handled by the server is an integer multiple of the cycle times of the other connections handled by the server. Optionally, each long cycle ends together with all the other cycles. Optionally, the order of connections having scheduled processing sessions during a plurality of long cycles which handle the same connections is substantially the same, when the quality of service (QoS) of the connections do not change. Thus, a scheduler managing the scheduling of processing sessions may determine an order of several connections to be handled one after the other, such that other modules of the server (e.g., a memory unit) may prepare resources for the processing, ahead of time.

An aspect of some embodiments of the present invention relates to a method of determining whether to accept an incoming candidate connection, for handling by a server. In some embodiments of the invention, the available processing time of the server and the required processing time of the candidate connection are determined and compared, and accordingly it is determined whether the candidate connection is accepted. In some embodiments of the present invention, a criteria by which the server decides if it should accept the candidate connection is whether the available processing time of the server is larger than the required processing time of the connection by at least a safety margin. The safety margin is optionally of a duration sufficient to prevent starvation of a connection due to normal changes in the processing times of the connections currently handled by the server.

In some embodiments of the present invention, the available processing time is determined by direct measurement. Alternatively or additionally, the available processing time is estimated based on the number of connections currently handled by the server and their average processing time utilization. In some embodiments of the present invention, the determination of the available processing time is performed by the server. Alternatively or additionally, the determination is performed by a router which provides the incoming candidate connections to the server.

An aspect of some embodiments of the present invention relates to a communication server which determines the order in which it processes data of various connections according to their quality of service (QoS). Optionally, the order in which a plurality of connections are handled may change, while the connections are carrying data, responsive to a change in the QoS of one or more of the connections and/or due to other considerations, such as distribution of starvation occurrences between connections.

An aspect of some embodiments of the present invention relates to a communication server including a processor which repeatedly handles data of a plurality of channels in processor cycles which end at driver controlled end-points. When a scheduler of the communication server identifies that the handling of one or more of the channels overflowed beyond the end-point of a current cycle, the scheduler takes measures to prevent such an overflow from occurring in a following cycle. In some embodiments of the invention, the scheduler skips the handling of one or more channels in the following cycle. Alternatively or additionally, the scheduler assigns one or more of the channels to receive a limited processing session in the following cycle. Optionally, the channels receiving a limited session and/or the channels being skipped comprise the channels which suffered from the overflow, so as to limit the number of suffering channels. Alternatively or additionally, the channels receiving a limited session and/or the channels being skipped comprise channels other than those which suffered from the overflow, so as to distribute the suffering between the channels.

An aspect of some embodiments of the present invention relates to a communication server in which the end-points of the processing cycles of data handling do not coincide with predetermined time points at which a driver begins to collect the processed data. In some embodiments of the invention, the pre-planned processing cycles end a predetermined time (e.g., 1 msec) before the collection time points. Thus, in case a channel requires a slightly longer processing session in a specific processing cycle, the driver does not collect data which is not ready yet. In some embodiments of the invention, the processor begins the processing of a following cycle before the driver begins to collect the data of a previous cycle.

An aspect of some embodiments of the present invention relates to a multi-channel communication server in which an output driver begins to retrieve the data processed for different channels during a single processing cycle, at different times. Optionally, the processor places processed data blocks of different channels at different relative memory locations, such that the output driver retrieves different locations in the processed data blocks of different channels at the same time. In some embodiments of the invention, the data block of each channel handled by the processor is placed in a more advanced point in the output buffer relative to the previous handled channel. Optionally, the data blocks of consecutive sessions of different channels are placed in the output buffer such that the transmission periods of the data of the sessions are partially overlapping. The term partially overlapping is used to describe the case where the periods do not entirely overlap. Using embodiments of the present invention, there is no need for the output buffer to wait for data of a later channel in forwarding data of an earlier channel. This can substantially reduce the delay caused by the communication server.

In some embodiments of the invention, an input driver places input data for the processor in an input buffer. Optionally, the processor retrieves the data of different channels from different relative points in the buffers, such that a channel which is processed later during a processing cycle, processes data received later in time. Thus, the delay between receiving the data and transferring the data after processing, is shortened.

An aspect of some embodiments of the present invention relates to a scheduler for communication servers which has standard interfaces to the software and/or hardware components of the communication software. Thus, the scheduler is easily replaced by updated versions. In addition, the scheduler is easily installed in other communication servers which have standard interfaces which are compatible with the standard interfaces of the scheduler.

There is therefore provided in accordance with an embodiment of the present invention, a method of scheduling the handling of data from a plurality of channels, including accumulating data from a plurality of channels by a remote access server, scheduling a processor of the server to handle the accumulated data from at least one first one of the channels, once during a first cycle time, and scheduling the processor to handle the accumulated data from at least one second one of the channels, once during a second cycle time, different from the first cycle time.

Optionally, the first cycle begins concurrently with a second cycle. Optionally, the first cycle time is an integer multiple of the second cycle time. Optionally, scheduling the processor to handle the accumulated data includes scheduling the processor, during the second cycle, to handle the accumulated data of substantially all the at least one second channels, before scheduling the processor to handle data from any other channels.

Optionally, scheduling the processor to handle the accumulated data from the at least one first one of the channels includes checking whether the second cycle has elapsed and scheduling the processor to handle the accumulated data from one the at least one first one of the channels only if the second cycle has not elapsed. Optionally, the at least one first one of the channels includes a plurality of first channels and the at least one second one of the channels includes a plurality of second channels. Optionally, the scheduling includes scheduling the processor to handle the accumulated data of at least one of the second channels at least twice before handling data from at least one of the first channels. Optionally, scheduling the processor to handle the accumulated data includes allowing the processor to utilize up to a predetermined amount of processing time of the processor for each channel.

Optionally, the processor does not execute an operating system adapted to perform preemption. Optionally, scheduling the processor includes having the processor wait without processing data from any of the channels if all the channels were processed during their respective current cycles. Optionally, the method includes measuring the amount of time in the first cycle time in which the processor is waiting and using the measured time in determining whether to accept handling data from an additional channel. Optionally, the scheduling is performed without interrupting the processor in the middle of handling accumulated data from a different channel. Optionally, the method includes processing an entire block of accumulated data of the scheduled channel responsive to the scheduling.

There is further provided in accordance with an embodiment of the present invention, a method of scheduling the handling of a plurality of connections, including accumulating data from a plurality of channels by a remote access server which includes a processor that does not run an operating system which performs preemption, and scheduling the processor to process data from a first one of the channels at least twice, without scheduling the processor to process data from a second one of the channels, therebetween.

Optionally, scheduling the processor includes scheduling the processor to handle data from the first one of the channels once during a first cycle time and scheduling the processor to handle data from the second one of the channels once during a second cycle time shorter than the first cycle time. Optionally, the method includes processing an entire block of accumulated data of the scheduled channel responsive to the scheduling.

There is further provided in accordance with an embodiment of the present invention, a remote access server, including a plurality of channel drivers which accumulate data from respective channels, a processor which processes the accumulated data, and a scheduler which schedules the processor to handle accumulated data from a first channel once during a first cycle time and data from a second channel once during a second cycle time different from the first cycle time, wherein the scheduler does not interrupt the operation of the processor while it is processing data from a channel.

Optionally, the scheduler schedules the processor to handle the data from the first channel at least twice before scheduling the processor to handle data from the second channel.

There is further provided in accordance with an embodiment of the present invention, a method of determining, by a remote access server, whether to accept an incoming connection, including determining an amount of unused processing time of a processor of the server, and determining whether the amount of unused processing time is sufficient to handle the incoming connection. Optionally, determining the amount of unused processing time includes determining by the processor. Optionally, determining the amount of unused processing time includes measuring time in which the processor does not process data from any connection.

Optionally, determining the amount of unused processing time includes estimating the amount of time based on a number of connections being handled by the server and/or based on the types of the connections being handled by the server.

Optionally, determining whether the amount of unused processing time is sufficient to handle the incoming connection includes determining whether the amount of unused processing time exceeds an amount sufficient to handle the incoming connection at least by a predetermined safety margin. Optionally, the safety margin has a size determined responsive to a number of connections being handled by the server.

There is further provided in accordance with an embodiment of the present invention, a method of scheduling the handling of data, by a remote access server tracking a short cycle and a long cycle, from a plurality of channels including at least one short cycle channel and at least one long cycle channel, including accumulating data from the plurality of channels by the server, scheduling a processor of the server to handle the accumulated data from all the short cycle channels, determining whether a current short cycle has elapsed after scheduling the server to handle the data from all the short cycle channels, and scheduling the processor to handle the accumulated data from a long cycle channel if the current short cycle did not elapse, if there is a long cycle channel which was not processed yet during the current long cycle.

Optionally, the method includes determining whether the current short cycle has elapsed after scheduling the server to handle the data from the long cycle channel, and scheduling the processor to handle the accumulated data from an additional long cycle channel, if the current short cycle did not elapse.

Optionally, the method includes waiting, after scheduling the server to handle the data from all the short cycle channels, until the beginning of the next short cycle without processing data from any channel, if all the long cycle channels were already processed during the current long cycle. Optionally, the long cycle begins concurrently with a short cycle. Optionally, the long cycle time is an integer multiple of the short cycle time.

There is further provided in accordance with an embodiment of the present invention, a method of scheduling the handling of a plurality of connections, including accumulating data from a plurality of channels by a remote access server, determining for at least one of the connections a quality of service level, and scheduling the processor to process data from the plurality of connections in an order determined responsive to the determined quality of service level. Optionally, the scheduling includes scheduling the processor to handle data from at least one first connection before handling data from at least one second connection having a lower quality of service level than the at least one first connection.

Optionally, the method includes changing the quality of service level of at least one of the connections while accumulating the data and changing the order of scheduling responsive to the change in the quality of service level.

There is further provided in accordance with an embodiment of the present invention, a method of scheduling the handling of a plurality of channels, comprising determining, for each of the channels, a target time by which the channel should be handled in order to avoid starvation of the channel, estimating for each of the channels a handling time required to handle a processing session of the channel, selecting a channel with a shortest available time, which available time is the time remaining until its target time less its handling time, scheduling the selected channel for handling, and processing, for the scheduled channel, an entire data block of a predetermined size, without interruption for handling of data of other channels. Optionally, the target time includes a safety margin.

There is further provided in accordance with an embodiment of the present invention, a remote access server, comprising one or more output buffers, at least one driver adapted to transmit signals from the one or more output buffers on a plurality of channels, and a processor adapted to repeatedly perform, for each of the channels, at a respective channel cycle, processing sessions in which data is placed in specific positions in the one or more output buffers, the specific positions in which the data is placed determine a period in which the placed data is transmitted by the driver, and the processor is adapted to place the data of processing sessions of at least two of the plurality of channels in positions such that the transmission periods of the data are partially overlapping.

Optionally, the processor is adapted to place the data of processing sessions of at least one of the channels in positions such that the transmission period of the data partially overlaps transmission of data from sessions of substantially all the other channels. In some embodiments of the invention, the one or more output buffers comprise a buffer for each of the plurality of channels. Optionally, the at least one driver begins to transmit data of each current session of the processor before it begins to transmit data of sessions performed by the processor after the current session. Possibly, the respective cycles of the channels are of substantially the same length. In some embodiments of the invention, the at least one driver is adapted to receive signals from the plurality of channels and to place the received signals in one or more input buffers, and the processor is adapted to retrieve data for processing sessions of at least two of the plurality of channels from different positions such that the reception periods of the data are partially overlapping.

There is further provided in accordance with an embodiment of the present invention, a method for preparing data for transmission by at least one driver adapted to transmit signals from one or more output buffers on a plurality of channels at times determined by locations of the data in the buffers, comprising performing a first processing session in which data for transmission on a first channel is placed in the one or more output buffers in a first location, performing a second processing session in which data for transmission on a second channel is placed in the one or more output buffers in a second location, the first and second locations are selected such that the data from the first and second processing sessions are transmitted by the driver during partially overlapping periods.

Optionally, the second processing session is performed after the first processing session and wherein the driver begins to transmit the data in the second location after beginning to transmit the data in the first location.

There is further provided in accordance with an embodiment of the present invention, a connection handling server, comprising one or more output buffers, at least one driver adapted to transmit signals from the one or more output buffers on a plurality of channels, a processor adapted to repeatedly perform, for each of the channels, at a respective channel cycle, processing sessions in which data for transmission is placed in the one or more output buffers, and a scheduler adapted to determine occurrence of a starvation state in which the at least one driver began to transmit data from a portion of the buffer before the processor placed data in the buffer portion.

Optionally, the scheduler is adapted to skip or limit one or more processing sessions of one or more of the channels responsive to the determination of the occurrence of a starvation state. Possibly, the scheduler skips or limits one or more processing sessions of one or more channels which were affected by the starvation state and/or which were not affected by the starvation state.

There is further provided in accordance with an embodiment of the present invention, a method of scheduling a processor of a remote access server, which server includes at least one driver adapted to transmit signals from one or more output buffers on a plurality of channels, comprising scheduling a processor to perform a processing session in which data is placed in a specific location in the one or more output buffers, and determining whether a starvation state occurred in which the at least one driver began to transmit data from the specific location before the processor completed the processing session. Optionally, the method includes instructing the processor to skip or limit one or more processing sessions of one or more of the channels responsive to determination of the occurrence of a starvation state.

There is further provided in accordance with an embodiment of the present invention, a connection handling server, comprising one or more output buffers, at least one driver adapted to transmit signals from one or more output buffers on a plurality of channels, a processor adapted to repeatedly perform, for each of the channels, during a common cycle, processing sessions in which data for transmission is placed in the one or more output buffers, the processor begins the processing of at least some of the common cycles before the at least one driver begins to transfer the data prepared during the previous common cycle. Optionally, the processor begins the processing of at least some of the common cycles at least 1 ms before the at least one driver begins to transfer the data prepared during the previous common cycle.

There is further provided in accordance with an embodiment of the present invention, a method for preparing data for transmission by at least one driver adapted to transmit signals from one or more output buffers, comprising placing data in the one or more output buffers for each of a plurality of channels, during a first cycle, and beginning to place data in the one or more output buffers for at least one of the plurality of channels in a second cycle, before the at least one driver began to transmit data placed in the one or more output buffers during the first cycle.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a connection handling server, in accordance with some embodiments of the present invention;

FIG. 2 is a flowchart of the actions performed by a scheduler in the server of FIG. 1, in accordance with some embodiments of the present invention;

FIG. 3 is a schematic time chart illustrating the operation of a scheduler of the server of FIG. 1, in accordance with some embodiments of the present invention;

FIG. 4 is a flowchart of the actions performed by a server in determining whether to accept an incoming connection, in accordance with some embodiments of the present invention;

FIG. 5 is schematic illustration of a scheduler table, in accordance with an embodiment of the present invention; and

FIG. 6 is a schematic illustration of input and output drivers in a stepped usage, in accordance with an embodiment of the present invention.

### DETAILED DESCRIPTION OF EMBODIMENTS

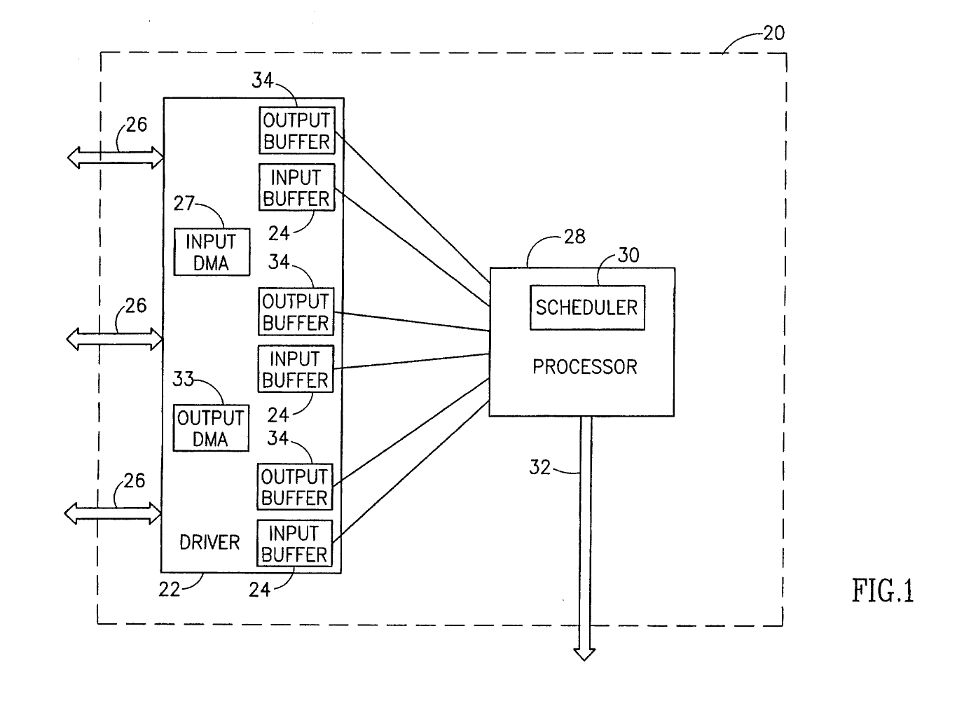

FIG. 1 is a schematic illustration of a connection handling server 20, in accordance with an exemplary embodiment of the present invention. Server 20 handles a plurality of channels 26 (referred to also as connections) from which it receives data and to which it transfers data. The data on channels 26 may comprise voice, fax, modem and/or any other type of communication signals. Server 20 optionally comprises a driver 22 which includes for each channel 26 an input buffer 24 and an output buffer 34. Driver 22 optionally places symbols from channels 26 into their respective input buffers 24 at a predetermined input rate and transfer symbols from the output buffers 34 to their respective channels 26 at a predetermined output rate, optionally equal to the input rate. A processor 28 periodically retrieves data from input buffers 24, processes the data and passes the processed data on an upper layer interface line 32. In addition, processor 28 receives data from interface line 32, processes the received data and places the processed data in output buffer 34. Optionally, in some cases, the contents of the output data placed in output buffer 34 depends on the contents of the data in input buffer 24.

In some embodiments of the invention, the input and/or output rates of driver 22 are a function of the type of data passing on the respective channel 26. In some embodiments of the invention, the rates of operation of the drivers may be set by a user of system 20.

Optionally, driver 22 comprises a single hardware unit and/or a common processor, optionally processor 28. Alternatively, some or all of channels 26 comprise separate hardware units which perform the tasks of driver 22 for the one or more channels.

In some embodiments of the invention, driver 22 comprises an input direct memory access (DMA) 27 which transfers data into buffers 24 from their respective channels 26 and/or an output DMA 33 which transfers data from buffers 34 to their respective channels 26. Alternatively, driver 22 comprises a single input and output DMA.

Server 20 may be employed as a stand alone server or may be used as part of an array of servers, of the same or different types. The array of servers is optionally used with a channel router, of any type known in the art, for example, the router described in PCT application PCT/IL00/00703, filed Nov. 1, 2000, which is assigned to the assignee of the present application, and the disclosure of which is incorporated herein by reference.

In some embodiments of the invention, processor 28 executes for each channel 26 a process which retrieves the data from buffer 24 and places data for transmission in buffer 34. Generally, the process of each channel 26 should be executed periodically within certain time constraints in order to ensure that data overwritten in input buffer 24 was already retrieved by processor 28 and/or that data transferred from output buffer 34 to channel 26 is new data recently placed by processor 28.

In some embodiments of the invention, each channel 26 has a respective cycle, having an associated cycle time, in which it should receive a handling session from processor 28. It is noted, however, that the connection does not necessarily receive the processing session at the same time point within each cycle. In some embodiments of the invention, at the end of the respective cycle of the channel, driver 22 begins to pass onto channel 26 the block of data from output buffer 34 prepared during the processing cycle. If the processing of the channel is not completed before the end of the cycle of the channel, the data retrieved from output buffer 34 may be old data, thus providing erroneous data onto channel 26. Optionally, output DMA 33 is set to begin retrieving the processed data a predetermined time, e.g., 0.5-5 msec, after the end of the cycle, such that a small delay in the processing does not cause an error.

Optionally, buffers 24 and/or 34 comprise first-in first-out (FIFO) cyclic buffers in which new data continuously overwrites old data. In some embodiments of the invention, buffers 24 and 34 have room to accommodate data of at least two processing cycles (optionally, of four to eight processing cycles) of each channel handled by server 20. Optionally, all the buffers 24 and/or 34 have the same size. Alternatively, different buffers have different sizes according to the lengths of the processing cycles of their respective channels.

A scheduler 30, which is optionally run on processor 28, sets the order in which processor 28 schedules processing sessions to the connections, and optionally the durations of the sessions. Generally, when scheduler 30 allocates a processing session to a connection, the connection utilizes an amount of processing time according to its needs. That is, in different cycles a connection may utilize different amounts of processing time and different connections may have different average processing times.

Optionally, once scheduler 30 allocates the use of processor 28 to a channel, the scheduler does not interrupt the processing of that channel until the processing of the channel is completed. Further optionally, processor 28 does not run an operating system which performs preemption. Not running an operating system that performs preemption reduces the processing power required from processor 28 and reduces the number of times data blocks required for processing need to be moved into the internal memory of the processor.

In some embodiments of the invention, scheduler 30 comprises a generic software which can be executed on different hardware platforms and/or can cooperate with various types of related units (e.g., operating systems, processes, DMAs). Optionally, a standardized set of commands is used to pass instructions between scheduler 30 and related units, such as driver 22 (including DMAs 27 and 33), the channel processes on processor 28, a memory manager, an operating system and/or an application programmer interface (API) which controls server 20. Optionally, the standardized set of commands does not relate to particularities of the implementation, such as buffer sizes.

In some embodiments of the invention, the connections handled by server 20 have either a short cycle or a long cycle. Optionally, the cycle sizes of the connections are integer multiples of each other (e.g., the long cycle is an integer multiple of the short cycle). The cycle schedules optionally overlap such that each long cycle begins at the same time as a short cycle and contains an integer number of short cycles. In the following description, the connections will be referred to according to their cycles, i.e., long cycle connections and short cycle connections. Scheduler 30 optionally operates a clock which keeps track of the short and long cycles.

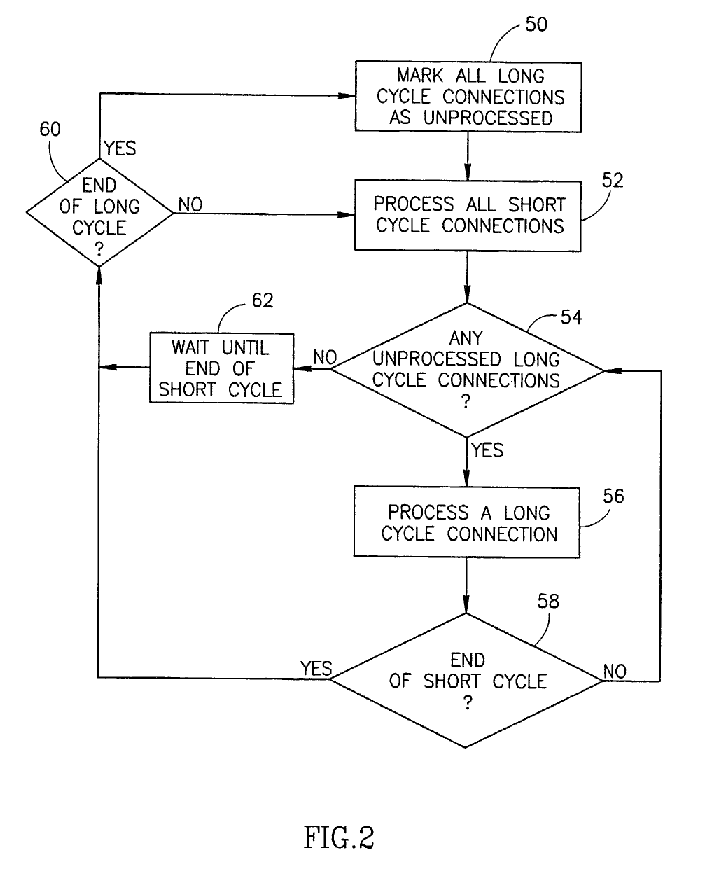

FIG. 2 is a flow chart of the actions performed by scheduler 30, in accordance with some embodiments of the present invention. At the beginning of each long cycle, scheduler 30 marks (50) all the long cycle connections as unprocessed. Thereafter, scheduler 30 optionally allocates (52) processing sessions on processor 28 to each of the short cycle connections.

After all the short cycle connections are allocated processing sessions, scheduler 30 optionally determines whether (54) any long cycle connections are marked as unprocessed. If there is at least one unprocessed long cycle connection, scheduler 30 chooses a long cycle connection to receive a processing session (56) and processor 28 processes the data of the chosen connection. After the processing of the long cycle connection, scheduler 30 checks (58) whether the current short cycle has elapsed. If the current short cycle has elapsed, scheduler 30 again allocates (52) processing sessions to each of the short cycle connections. If (60) the end of the current short cycle ends a long cycle, scheduler 30 marks (50) all the long cycle connections as unprocessed before allocating processing sessions to the short cycle connections. If the current short cycle has not elapsed (58), another long cycle connection is allocated a processing session, if an unprocessed connection exists. Otherwise, processor 28 waits (62) until the end of the current short cycle.

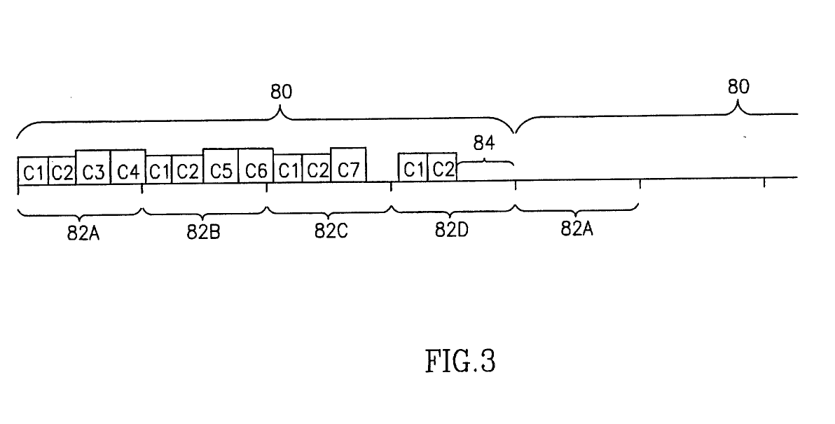

Referring additionally to FIG. 3, FIG. 3 is a schematic time chart illustrating the operation of scheduler 30 on two short cycle connections (C1, C2) and five long cycle connections (C3, C4, C5, C6 and C7), in accordance with an embodiment of the present invention. A long cycle 80, which is for example 20 milliseconds long, includes, for example, four short cycles 82 (marked 82A, 82B, 82C and 82D) of 5 milliseconds each. At the beginning of each long cycle 80, the two short cycle channels C1 and C2 are processed. Thereafter long cycle channels C3 and C4 are processed. After channel C4 is processed, short cycle 82A has already elapsed. Therefore, channels C1 and C2 are again processed. Although the time between consecutive processing sessions of channels C1 and C2 in cycles 82A, 82B and 82C are longer than their cycle the channels do not starve, as they receive a processing session during each cycle.

Two more long cycle channels C5 and C6 are then processed, as there is sufficient time to begin their processing before the end of short cycle 82B. After short cycle 82B has elapsed, channels C1 and C2 are again processed. Afterwards, long cycle channel C7 is processed. Since there are no more long cycle channels which were unprocessed, processor 28 remains idle until the end of short cycle 82C. In short cycle 82D, only channels C1 and C2 are processed and processor 28 remains idle until the end of long cycle 80. In a next long cycle 80 this process is repeated.

In some embodiments of the invention, a safety period after the end of each short cycle 82, driver 22 (FIG. 1) begins to transfer the output data in buffer 34 of short cycle channels C1 and C2 on channel 26. Likewise, a safety period after the end of each long cycle 80, driver 22 begins to transfer the data of from buffer 34 of the long cycle channels, e.g., C3, C4, C5, C6 and C7. The safety period adds robustness to system 20. For example, if a processing session of one of the channels goes slightly beyond the end of a long cycle 80 (due to a rare occurrence), driver 22 does not retrieve from buffer 34 old data. It is noted, however, that the safety period adds to the total delay of system 20. Therefore, the safety period is optionally chosen as a compromise between the delay it adds and the additional robustness it provides. In an exemplary embodiment of the invention, the safety period is between 0.5 to 5 msec for a 30 msec long cycle. The duration of the safety period may depend, for example, on the extent of the uncertainty in the processing times of the sessions performed by processor 28. In some embodiments of the invention, during the safety period processor 28 continues to perform processing sessions, and normally begins a new processing cycle, although driver 34 did not begin to transfer to channels 26 the data from the previous cycle.

In some embodiments of the invention, scheduler 30 schedules processing sessions to begin only after a signal from input DMA 27 is received indicating that the input data of the channel was already placed in buffer 24. Alternatively or additionally, scheduler 30 schedules processing sessions only a predetermined time (e.g., 0.5 msec) after the data to be processed during the session was scheduled to be placed in buffer 24.

As described above, at least one long cycle channel is allocated a processing session (if an unprocessed connection remains) during each short cycle. Alternatively, scheduler 30 checks (58) whether the current short cycle elapsed, before checking (54) whether any unprocessed long cycle connections remain. In some embodiments of the invention, scheduler 30 checks (58) whether the current short cycle elapsed before checking (54) whether any unprocessed long cycle connections remain only for the second and later short cycles of a long cycle. This is because, if at least one long cycle connection is being handled by server 20, it is substantially impossible that the first short cycle (82A) will elapse before the processing of one or more long cycle connection begins.

In some embodiments of the invention, the short and/or long cycle connections are allocated processing sessions in a fixed order such that in all the long cycles 80 the order of processing is the same. Optionally, the processing order is determined according to the quality of service (QoS) levels of the respective connections, such that connections with a high QoS are processed before connections with lower QoS. Thus, if due to unexpected extreme changes in the processing times required by the connections, one of the connections suffers from starvation, it will then be a connection with lowest QoS. Alternatively or additionally, the order of processing is determined based on the number of times each channel suffered from starvation. For example, a channel which due to its being last in the processing order suffered from starvation may be moved up in the processing order.

The QoS of a connection may change during the handling of the connection by server 20. When such a change occurs, the position of the connection in the order of connections to be processed in further cycles is optionally adjusted responsive to the change in the QoS.

In some embodiments of the invention, scheduler 30 keeps track of the utilization level of processor 28. Optionally, scheduler 30 determines for each long cycle 80, the amount of idle time during which processor 28 is waiting (62), i.e., not processing any channel. In addition, scheduler 30 optionally determines the idle time 84 in the short cycle which is least utilized, i.e., the last short cycle 82D within a long cycle. The determined idle times are optionally used in determining whether an additional channel may be handled by server 20. In some embodiments of the invention, the idle time during a long cycle 80 is represented as a percentage of the length of the cycle, and such representation may be used as a measure of the efficiency of server 20. Alternatively or additionally, the idle time is represented in absolute times.

Alternatively or additionally to determining the time in which processor 28 is idle, scheduler 30 keeps track of the number of connections being processed by server 20 and the processing time of each connection. Accordingly, scheduler 30 calculates the current (and expected) idle time of processor 28. Optionally, scheduler 30 is notified of any change in the processing time utilized by one of the connections, so that it can precisely track the idle time of the processor. For example, scheduler 30 keeps track of addition and removal of connections, changes in the cycle lengths of the connections and changes in the processing times of the connections in each cycle.

In some embodiments of the invention, the idle times are determined based on approximations. For example, scheduler 30 may not be able to know the exact processing time required by each connection, and instead uses average processing times according to the types of the connections (e.g., fax, modem, VoIP).

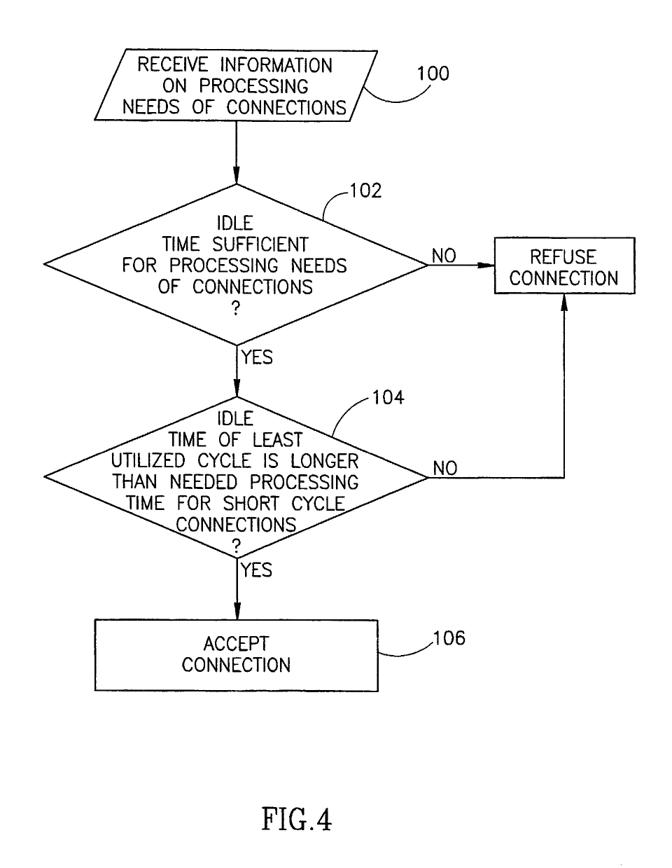

FIG. 4 is a flowchart of the actions performed by server 20 in determining whether to accept an incoming candidate connection, in accordance with an exemplary embodiment of the present invention. Optionally, server 20 receives (100) for each of the incoming connections, its cycle length, i.e., whether the connection requires processing every short cycle or long cycle, and its average required processing time per cycle. Scheduler 30 optionally determines (102) whether the idle time during a recent long cycle is sufficient in order to process the incoming connection. That is, if the incoming connection is a long cycle connection, scheduler 30 determines whether the average required processing time of the incoming connection is shorter than the available idle time of the recent long cycle. If, however, the incoming connection is a short cycle connection, scheduler 30 optionally determines whether the average required processing time multiplied by the number of short cycles in a long cycle is shorter than the available idle time of the recent long cycle.

Optionally, if the candidate incoming connection is a short cycle connection, scheduler 30 also verifies (104) that the idle time 84 of the least utilized cycle is longer than the average required processing time. If there is enough time to handle the incoming connection, the connection is accepted (106). Otherwise the incoming connection is refused by server 20. Such refusal may result in a busy signal or in passing the incoming connection to a different server by a controlling router.

In some embodiments of the invention, the method of FIG. 4 is also performed when a connection requests to switch from being allocated a processing session each long cycle to being allocated a processing session each short cycle. Alternatively or additionally, the method of FIG. 4 is also performed when a connection requests to switch from being allocated a processing session each short cycle to being allocated a processing session each long cycle. In some embodiments of the present invention, the method of FIG. 4 is performed when a connection requests to increase its processing time utilization during long cycles. Such increase may be due, for example, to switching between being allocated a processing session each short cycle and being allocated a processing session each long cycle and/or due to a change in the type of the connection (e.g., an increase or decrease in the transmission rate of the connection) or due to any other reason.

In some embodiments of the invention, scheduler 30 accepts an incoming connection only if a predetermined amount of reserve processing time will remain after the incoming connection is accepted. The reserve processing time is useful in case one or more of the existing connections will require additional processing time. For example, the reserve processing time may be used in case an existing connection switches from receiving processing time each long cycle 80 to each short cycle 82, or when an existing connection requires a longer processing time during each cycle.

In some embodiments of the present invention, one or more connections may require processing periods which vary between cycles. Such connections are optionally evaluated based on their average and/or maximum utilization. The reserve processing time protects against starvation in case the processing utilization temporarily increases during one or more long cycles 80.

In some embodiments of the invention, the amount of processing time reserved by scheduler 30 depends on the number of connections handled by server 20. Alternatively or additionally, the amount of reserved processing time depends on the number of handled connections which are utilizing substantially less processing time than a maximal amount of processing time which may be utilized by a connection. In some embodiments of the invention, the amount of reserved processing time depends on the number of channels which are processed during long cycles 80 and which may be converted to short cycles 82.

In some embodiments of the present invention, the amount of reserve processing time is chosen in order to achieve a predetermined chance of channel starvation. For example, a user may choose to use a relatively large amount of reserve processing time in order to prevent channel starvation at the expense of being able to handle fewer connections concurrently. Alternatively, a small amount of reserve time is used in order to maximize the number of connections handled by server 20 although allowing a higher starvation chance.

In some embodiments of the invention, the lengths of long cycle 80 and/or of short cycle 82 may be changed by a system manager of server 20 when the server is not in use. Such a change may include changing the length of long cycle 80 and/or of the number of short cycles 82 within a single long cycle 80. Alternatively or additionally, the lengths of long cycle 80 and/or of short cycle 82 may be changed during the operation of server 20. Optionally, before changing the length of either of cycles 80 or 82, processor 28 verifies that such a change will not cause starvation to any of the connections currently handled by the processor.

In some embodiments of the invention, all of drivers 22 accumulate the data at a common sampling rate. In an exemplary embodiment, the sampling rate of drivers 22 is 8 kHz, the length of short cycle 82 is 5 msec and the length of long cycle 80 is 20 msec. Thus, in each short cycle, drivers 22 accumulate 40 samples and in each long cycle the drivers accumulate 160 samples.

It is noted that each connection should receive a processing session during every cycle (large or small), but the amount of time between consecutive processing sessions of a connection may be larger than the cycle. The interval between two consecutive processing sessions of a connection may be, under some conditions, close to twice the cycle of the connection. It is further noted that the time between consecutive processing sessions may be shorter than a cycle, for example, when a different connection is disconnected from server 20 or when the QoS of one or more of the connections, changes.

Although the above description refers to connections having either a short cycle or a long cycle, some embodiments of the invention may be implemented with substantially any number of different cycles, as is now described.

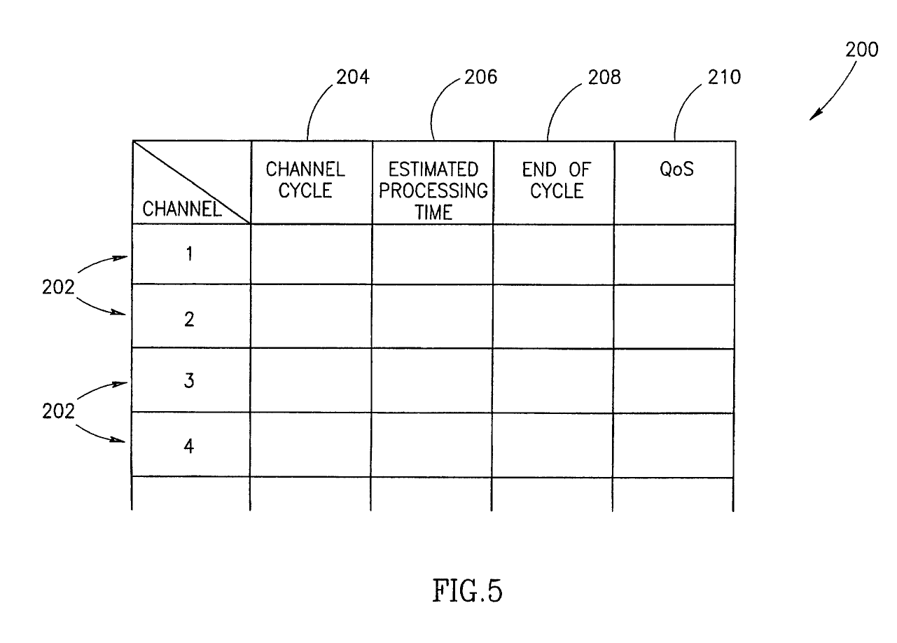

FIG. 5 is schematic illustration of a table 200 of scheduler 30, in accordance with an embodiment of the present invention. For each channel handled by server 20, table 200 comprises a record 202 which lists the cycle of the channel 204, the estimated time required to handle the channel in each cycle 206 and/or the time at which the channel's next cycle ends 208. In some embodiments of the invention, the cycle of a channel ends when driver 22 is scheduled to collect processed data of the channel from output buffer 34. Alternatively, the cycle of a channel is scheduled to end a predetermined time before driver 22 is scheduled to begin collection of the processed data, so that slight delays beyond the end of the cycle do not cause transfer of erroneous data. As described above, the length of the predetermined time may depend, for example, on the variance of the processing times of the sessions performed by processor 28.

Alternatively or additionally to stating the time at which the next cycle of the channel ends 208, table 200 states the time at which the channel was previously handled. The time at which the channel was previously handled 208 may be stated as the beginning and/or end time.

In some embodiments of the invention, in determining which channel is to be scheduled, scheduler 30 calculates for each channel the time remaining until it must receive a handling session, such that its handling is completed before the end of its respective cycle. Optionally, the channel with the shortest remaining time is selected to be processed. In some embodiments of the invention, the remaining time is calculated as the time until the end of the respective cycle of the channel minus the estimated time required to handle the channel. Optionally, the estimated time required to handle the channel is calculated as an average or maximum of the time consumed in previous handling sessions of the channel. Alternatively or additionally, the estimated required time is calculated as a function of one or more attributes of the channel, e.g., the type of data it caries (modem, fax, voice).

In some embodiments of the invention, table 200 of scheduler 30 lists the quality of service (QoS) 210 of each channel. Optionally, when a plurality of channels have the same (shortest) time remaining until the end of their respective cycle, the processor is optionally scheduled to process the channel with the highest QoS rating. In some embodiments of the present invention, when two or more channels have the same cycle and the same QoS, the scheduler selects one of the channels randomly. Alternatively, scheduler 30 assigns an arbitrary order to each of the two or more channels such that the scheduler substantially always schedules the two or more channels in a same order. Alternatively or additionally, the table of scheduler 30 lists the most recent time in which each channel was handled. When a plurality of channels are otherwise with equal right for processing, the channel waiting for processing for the longest duration, precedes.

Further alternatively or additionally, scheduler 30 keeps track of the occasions in which channels did not receive a processing session on time (i.e., before the driver retrieves the processed data). Optionally, scheduler 30 determines which channel is to be handled earlier, according to the number of occasions in which the channels did not receive processing sessions on time. Further alternatively or additionally, other methods, for example as described in PCT application PCT/IL00/00733, filed Nov. 9, 2000, the disclosure of which is incorporated herein by reference, are used to select for scheduling one of a plurality of channels with equal time remaining until they must be processed.

Optionally, if a channel suffers from starvation, server 20 attempts to continue with the handling of the connection although it suffered from starvation. The starvation may be identified and corrected by an error correction (EC) layer which requests retransmission of the lost data and/or by performing a retrain on the connection.

In some embodiments of the invention, when scheduler 30 determines that the processing session of one of the channels (referred to herein as the starved channel) ended after the driver picked up the data of the channel, it skips and/or shortens the handling session of one or more of the channels in the following cycle of the starved channel. The skipping and/or shortening of the handling session of the one or more channels reduces the chances that the late ending of the processing session will be repeated. In some embodiments of the invention, scheduler 30 skips and/or shortens the handling session of the starved channel. Alternatively or additionally, scheduler 30 skips and/or shortens the handling session of one or more channels other than the starved channel.

In some embodiments of the invention, the skipping and/or shortening of the handling session of the one or more channels are performed in a manner which does not cause the other end of the connection to disconnect the connection. Alternatively or additionally, the skipping and/or shortening of the handling session is not noticed by the other end apparatus of the connection, except possibly due to a retrain or retransmission request initiated by server 20.

Optionally, shortening the processing session of one or more of the channels comprises scheduling the channel to receive a limited processing session. In some embodiments of the invention, limiting the processing session of a connection comprises reducing the processing power utilization of the reception portion of the connection. Alternatively or additionally, limiting the processing session of a connection comprises reducing the processing power utilization of the transmission portion of the connection. Further alternatively or additionally, limiting the processing session comprises processing a reduced size block of the accumulated data. Optionally, the limiting of the processing session comprises not performing one or more tasks performed in unlimited sessions of the connection. In some embodiments of the invention, limiting the processing session of a modem connection comprises not performing one or more of the tasks of the decoding layer of the data pump (for example, in the V.34 the Viterbi decoder, shell dewrapper, deprecoder, non-linear decoder and/or descrambler). Alternatively or additionally, limiting the processing session of a modem connection comprises not performing the tasks of the data-pump and/or the ECDC layers. In some embodiments of the invention, limiting the processing session of a fax connection comprises not performing the tasks of the data pump and/or protocol layers. In some embodiments of the invention, limiting the processing session of a voice connection comprises ignoring a certain percentage of received signals and/or not performing the tasks of the vocoder. In some embodiments of the invention, limiting of the processing session comprises changing one or more parameters of the handling, for example, reducing the length of a filter used and/or changing from soft decision to hard decision.

Alternatively or additionally, limiting the processing session is performed in accordance with any of the methods described in above mentioned PCT application PCT/IL00/00733, U.S. Pat. No. 5,995,540 to Draganic and/or in U.S. patent application Ser. No. 08/969,981 to Abraham Fisher et al, filed Nov. 13, 1997, the disclosures of which documents are incorporated herein by reference.

In some embodiments of the invention, scheduler 30 selects channels to be processed a predetermined time before they are actually processed. For example, scheduler 30 may instruct a memory controller to load into a memory associated with processor 28, data relating to a channel which is going to be processed at a later time. Alternatively or additionally, scheduler 30 checks in advance for several channels that they will receive processing sessions on time. Optionally, if it is estimated that one or more of the channels will not receive a session on time, scheduler 30 assigns one of the channels to receive a limited processing session, for example as described in PCT application PCT/IL00/00733.

In some embodiments of the invention, each time processor 28 processes a connection, it processes only a single input block of samples, including samples accumulated in a single cycle of the connection, even if more samples have been accumulated in the respective buffer 24. In addition, processor 28 generates only a single output block of samples which are placed in output buffer 34. Thus, the processing time required to process a connection is substantially constant, simplifying the estimation of the processing time required by each connection.

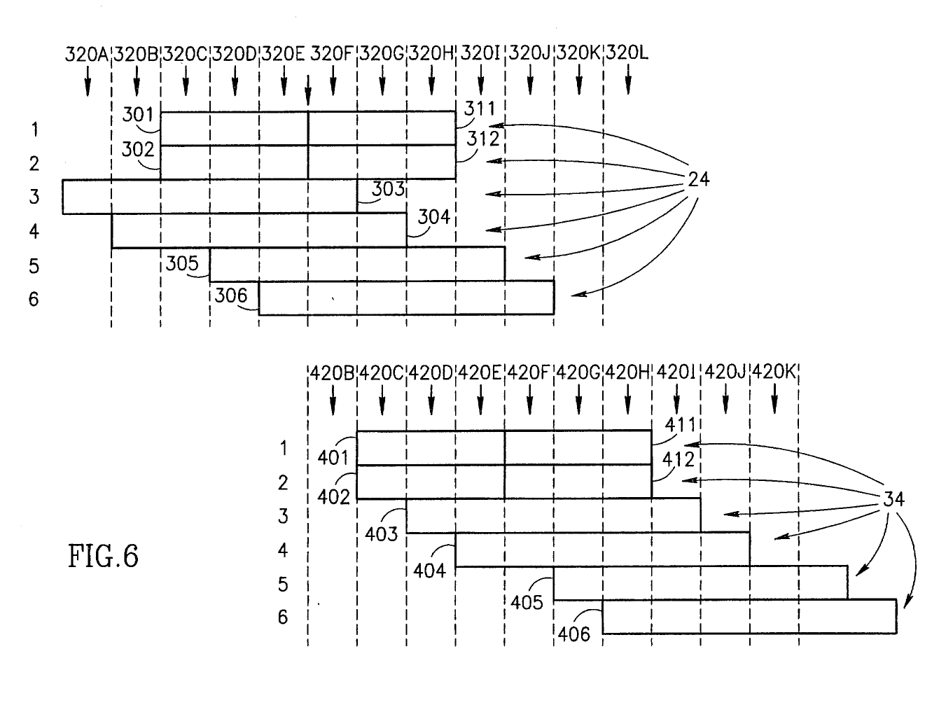

Optionally, the single input block comprises a block of symbols accumulated during a previous cycle of the cycle scheme of the connection, and the output block of samples is transferred by driver 22 at about the end of the current cycle of the cycle scheme of the connection. Thus, the same data samples of the connection are processed by processor 28 regardless of the relative time in its cycle in which the processor is scheduled to handle the data of the connection. Alternatively, as described with reference to FIG. 6, the input and/or output blocks comprise blocks of symbols accumulated substantially immediately before the processing begins and exported by driver 22 substantially immediately after they are placed in output buffer 34. This reduces the delay between receiving data from channel 26 and transmitting a response thereto onto channel 26.

In some embodiments of the invention, scheduler 30 may assign one or more of channels 26 to perform a short processing session which handles less than a single block of data. Such short processing session may be used instead of regular processing sessions when processor 28 is short of processing power.

FIG. 6 is a schematic illustration of input buffers 24 and output buffers 36, in accordance with an embodiment of the present invention. In the embodiment of FIG. 6, processing sessions of different channels during a single common cycle are performed on data accumulated in buffer 24 at different, possibly partially overlapping, times.

As described above, drivers 22 continuously add data into buffers 24 and extract data from output buffers 34. In FIG. 6, data received at the same time is shown on a common memory slice 320 or 420. For the following explanation each slice 320 or 420 is assumed to include 5 ms of data. Possibly, slices 320F, 320G, 320H, etc. coincide with slices 420B, 420C, 420D, etc.

In the example of FIG. 6, the processing cycles of channels 1 and 2 are 15 ms, while the processing cycles of channels 3, 4, 5 and 6 are 30 ms. The processing sessions of channels 1 and 2 take about 2.5 ms and the processing sessions of channels 3, 4, 5 and 6 take about 5 ms. In the processing of a channel, processor 28 retrieves from input buffer 24 of the channel data accumulated during a time period equal to the length of the cycle of the channel and places data into output buffer 34 which will be transmitted during the same time period.

In some embodiments of the invention, the retrieval points of data from buffers 24 are organized such that generally the data of a channel is retrieved shortly after the last memory slice 320 of the retrieved data is filled by driver 22 with raw data. Similarly, in some embodiments of the invention, the data placement points in buffers 34 are set, such that the processed data is placed in buffer 34 shortly before the first slice 420 of the placed data is output by driver 22.

The following description is an exemplary order of occurrences for a common processing cycle of 30 ms:

Processor 28 handles channel 1, retrieves 15 ms of data from a raw data area 301. In addition, processor 28 places data for transmission in a data area 401 of buffer 34 of channel 1.

Processor 28 handles channel 2, retrieves 15 ms of data from a raw data area 302. In addition, processor 28 places data for transmission in a data area 402 of buffer 34 of channel 2.

At this point driver 22 finishes placing data in memory slice 320F and begins placing data in memory slice 320G. In addition, driver 22 finishes exporting data from slice 420B and begins exporting data from slice 420C.

Processor 28 retrieves 30 ms of data of channel 3 from a raw data area 303. In addition, processor 28 places data for transmission in a data area 403 of buffer 34 of channel 3.

At this point driver 22 finishes placing data in memory slice 320G and begins placing data in memory slice 320H. In addition, driver 22 finishes exporting data from slice 420C and begins exporting data from slice 420D.

Processor 28 retrieves 30 ms of data of channel 4 from a raw data area 304. In addition, processor 28 places data for transmission in a data area 404 of buffer 34 of channel 4.

At this point driver 22 finishes placing data in memory slice 320H and begins placing data in memory slice 320I. In addition, driver 22 finishes exporting data from slice 420D and begins exporting data from slice 420E.

Processor 28 handles channel 1, retrieves 15 ms of data from a raw data area 311. In addition, processor 28 places data for transmission in a data area 411.

Processor 28 handles channel 2, retrieves 15 ms of data from a raw data area 312. In addition, processor 28 places data for transmission in a data area 412.

At this point driver 22 finishes placing data in memory slice 320I and begins placing data in memory slice 320J. In addition, driver 22 finishes exporting data from slice 420E and begins exporting data from slice 420F.

Processor 28 retrieves 30 ms of data of channel 5 from a raw data area 305. In addition, processor 28 places data for transmission in a data area 405.

At this point driver 22 finishes placing data in memory slice 320J and begins placing data in memory slice 320K. In addition, driver 22 finishes exporting data from slice 420F and begins exporting data from slice 420G.

Processor 28 retrieves 30 ms of data of channel 6 from a raw data area 306. In addition, processor 28 places data for transmission in a data area 406.

At this point driver 22 finishes placing data in memory slice 320K and begins placing data in memory slice 320L. In addition, driver 22 finishes exporting data from slice 420G and begins exporting data from slice 420H.

In some embodiments of the invention, the delay caused by the handling of channels 1 and 2 includes the 15 ms during which the handled data, i.e., 301, 302, 311 and 312, is accumulated, and up to 5 ms for processing (i.e., about 5 ms for channel 1 and 2 until the data of channel 1 is transmitted, and 2.5 ms for channel 2). The delay of channels 3, 4, 5 and 6 includes 30 ms for accumulating the data and 5 ms for processing. It is noted that in the prior art, all of the channels (which in the prior art would have a common cycle), would retrieve data from the same memory slices 320. In addition, in the prior art all of the channels would place their data in the same slices 420. Therefore, the total delay caused by a prior art server would be about 60 ms.

It is noted that although in some embodiments of the invention both the retrieval of data from buffers 24 and the placement of data in buffers 34 are performed in the stepwise arrangement shown in FIG. 6, at least some of the advantages in shortening the delay may be achieved by using the step arrangement only in buffers 24 or only in buffers 34. For example, if the stepwise arrangement is used only with respect to output buffers 34, channels receiving earlier sessions in a common processing cycle have a shorter delay than channels later in the common processing cycle. In these embodiments, channels requiring a shorter delay are optionally scheduled to receive processing sessions at the beginning of the common cycle.

In some embodiments of the invention, a safety period is kept between the time at which the channel processing sessions are scheduled to end and the times at which the data they store in output buffer 34 is retrieved by driver 22. The length of the gap is optionally a function of the uncertainty in the time at which the processing sessions of the channels are scheduled. When there are many critical points, due to the retrieval of the data placed in buffer 34 being close to the placement of the data, the gap is optionally relatively large (e.g., 2-4 msec).

Alternatively or additionally to processor 28 relating to different positions in different buffers 34 and/or 24, DMA 27 places the data it retrieves from different channels 26 in different relative locations in buffers 24 and/or DMA 33 retrieves data from different relative positions in output buffers 34 to channels 26.

It will be appreciated that the above described methods may be varied in many ways, including, changing the order of steps, and/or performing a plurality of steps concurrently. For example, the order of the acts indicated as 102 and 104 in FIG. 4 may be interchanged and/or these acts may be performed concurrently. It should also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

1. A method of scheduling the handling of data from a plurality of channels, comprising:
accumulating data from a plurality of channels by a remote access server;
scheduling a processor of the server to handle the accumulated data from at least one first one of the channels, once during a first cycle time; and
scheduling the processor to handle the accumulated data from at least one second one of the channels, once during a second cycle time, different from the first cycle time.

2. A method according to claim 1, wherein the first cycle begins concurrently with the second cycle.

3. A method according to claim 2, wherein the first cycle time is an integer multiple of the second cycle time.

4. A method according to any of the preceding claims, wherein scheduling the processor to handle the accumulated data comprises scheduling the processor, during the second cycle, to handle the accumulated data from substantially all the at least one second channels, before scheduling the processor to handle data from any other of the plurality of channels.

5. A method according to claim 4, wherein scheduling the processor to handle the accumulated data from the at least one first one of the channels comprises checking whether the second cycle has elapsed and scheduling the processor to handle the accumulated data from one of the at least one first channels only if the second cycle has not elapsed.

6. A method according to any of the preceding claims, wherein the at least one first one of the channels comprises a plurality of first channels and the at least one second one of the channels comprises a plurality of second channels.

7. A method according to any of the preceding claims, wherein the scheduling comprises scheduling the processor to handle the accumulated data from at least one of the second channels at least twice before scheduling the processor to handle data from at least one of the first channels.

8. A method according any of the preceding claims, wherein scheduling the processor to handle the accumulated data comprises allowing the processor to utilize up to a predetermined amount of processing time for each channel.

9. A method according to any of the preceding claims, wherein the processor does not execute an operating system operative to perform preemption.

10. A method according to any of the preceding claims, wherein scheduling the processor comprises having the processor wait without handling data from any of the channels if all the channels were scheduled for handling during their respective current cycles.

11. A method according to claim 10, comprising measuring the waiting time of the processor in the first cycle and using the measured time in determining whether to accept handling data from an additional channel.

12. A method according to any of the preceding claims, wherein the scheduling of handling the data of one channel is performed without interrupting the processor in the middle of handling accumulated data from a different channel.

13. A method according to any of the preceding claims, comprising processing an entire block of accumulated data of the scheduled channel responsive to the scheduling.

14. A method of scheduling the handling of a plurality of connections, comprising:
accumulating data from a plurality of channels by a remote access server which includes a processor that, responsive to being scheduled to handle a channel, processes data of the channel without interruption for handling data of other channels;
scheduling the processor to process data from a first one of the channels at least twice, with a first interval between the schedulings; and
scheduling the processor to process data from a second one of the channels at least twice, with a second interval between the schedulings, which second interval includes the entire first interval.

15. A method according to claim 14, wherein scheduling the processor comprises scheduling the processor to handle data from the first one of the channels once during a first cycle time and scheduling the processor to handle data from the second one of the channels once during a second cycle time longer than the first cycle time.

16. A method according to claim 14 or claim 15, comprising processing an entire block of accumulated data of the scheduled channel responsive to the scheduling.

17. A remote access server, comprising:
a plurality of channel drivers which accumulate data from respective channels;
a processor which handles the accumulated data; and
a scheduler which schedules the processor to handle accumulated data from a first channel once during a first cycle time and data from a second channel once during a second cycle time different from the first cycle time, without interrupting the processor while it is processing data from a channel.

18. A server according to claim 17, wherein the scheduler schedules the processor to handle the data from the first channel at least twice before scheduling the processor to handle data from the second channel.

19. A method of determining, by a remote access server (RAS), whether to accept an incoming connection, comprising:
determining, by the remote access server, an indication of an amount of unused processing time of a processor of the server; and
determining whether the amount of unused processing time is sufficient to handle the incoming connection.

20. A method according to claim 19, wherein determining an indication of the amount of unused processing time comprises determining by the processor.

21. A method according to claim 19 or claim 20, wherein determining an indication of the amount of unused processing time comprises measuring the amount of time in which the processor does not process data from any connection.

22. A method according to any of claims 19-21, wherein determining an indication of the amount of unused processing time comprises estimating the amount of time based on a number of connections being handled by the server.

23. A method according to claim 22, wherein estimating the amount of time comprises estimating based on the types of the connections being handled by the server.

24. A method according to any of claims 19-23, wherein determining whether the amount of unused processing time is sufficient to handle the incoming connection comprises determining whether the amount of unused processing time exceeds an amount sufficient to handle the incoming connection at least by a predetermined safety margin.

25. A method according to claim 24, wherein the safety margin has a size determined responsive to a number of connections being handled by the server.

26. A method of scheduling the handling of data, by a remote access server keeping track of a short cycle and a long cycle, from a plurality of channels including at least one short cycle channel and at least one long cycle channel, comprising:
accumulating data from the plurality of channels by the server;
scheduling a processor of the server to handle the accumulated data from all the short cycle channels;
determining whether a current short cycle has elapsed after scheduling the processor to handle the data from all the short cycle channels; and
scheduling the processor to handle the accumulated data from one of the at least one long cycle channel if the current short cycle did not elapse, if there is a long cycle channel which was not scheduled yet during the current long cycle.

27. A method according to claim 26, comprising determining whether the current short cycle has elapsed after scheduling the processor to handle the data from the long cycle channel, and scheduling the processor to handle the accumulated data from an additional long cycle channel, if the current short cycle did not elapse.

28. A method according to claim 26 or claim 27, comprising waiting, after scheduling the processor to handle the data from all the short cycle channels, until the beginning of the next short cycle without processing data from any channel, if all the long cycle channels were already scheduled during the current long cycle.

29. A method according to any of claims 26-28, wherein the long cycle begins concurrently with a short cycle.

30. A method according to any of claims 26-29, wherein the long cycle time is an integer multiple of the short cycle time.

31. A method of scheduling the handling of a plurality of channels, comprising:
accumulating data from a plurality of channels by a remote access server;
determining for at least one of the channels a quality of service level; and
scheduling the processor to process data from the plurality of channels in an order determined responsive to the determined quality of service level.

32. A method according to claim 31, wherein the scheduling comprises scheduling the processor to handle data from at least one first channel before handling data from at least one second channel having a lower quality of service level than the at least one first channel.

33. A method according to claim 31 or claim 32, comprising changing the quality of service level of at least one of the channels while accumulating the data and changing the order of scheduling responsive to the change in the quality of service level.

34. A method of scheduling the handling of a plurality of channels, comprising:
determining, for each of the channels, a target time by which the channel should be handled in order to avoid starvation of the channel;
estimating for each of the channels a handling time required to handle a processing session of the channel;
selecting a channel with a shortest available time, which available time is the time remaining until its target time less its handling time;
scheduling the selected channel for handling; and
processing, for the scheduled channel, an entire data block of a predetermined size, without interruption for handling of data of other channels.

35. A method according to claim 34, wherein the target time includes a safety margin.

36. A remote access server, comprising:
one or more output buffers;
at least one driver adapted to transmit signals from the one or more output buffers on a plurality of channels; and
a processor adapted to repeatedly perform, for each of the channels, at a respective channel cycle, processing sessions in which data is placed in specific positions in the one or more output buffers;
wherein the specific positions in which the data is placed determine a period in which the placed data is transmitted by the driver, and
wherein the processor is adapted to place the data of processing sessions of at least two of the plurality of channels in positions such that the transmission periods of the data are partially overlapping.

37. A server according to claim 36, wherein the processor is adapted to place the data of processing sessions of at least one of the channels in positions such that the transmission period of the data partially overlaps transmission of data from sessions of substantially all the other channels.

38. A server according to claim 36, wherein the one or more output buffers comprise a buffer for each of the plurality of channels.

39. A server according to claim 36, wherein the at least one driver begins to transmit data of each current session of the processor before it begins to transmit data of sessions performed by the processor after the current session.

40. A server according to claim 36, wherein the respective cycles of the channels are of substantially the same length.

41. A server according to claim 36, wherein the at least one driver is adapted to receive signals from the plurality of channels and to place the received signals in one or more input buffers, and the processor is adapted to retrieve data for processing sessions of at least two of the plurality of channels from different positions such that the reception periods of the data are partially overlapping.

42. A method for preparing data for transmission by at least one driver adapted to transmit signals from one or more output buffers on a plurality of channels at times determined by locations of the data in the buffers, comprising:
performing a first processing session in which data for transmission on a first channel is placed in the one or more output buffers in a first location;
performing a second processing session in which data for transmission on a second channel is placed in the one or more output buffers in a second location,
wherein the first and second locations are selected such that the data from the first and second processing sessions are transmitted by the driver during partially overlapping periods.

43. A method according to claim 42, wherein the second processing session is performed after the first processing session and wherein the driver begins to transmit the data in the second location after beginning to transmit the data in the first location.

44. A connection handling server, comprising:
one or more output buffers;
at least one driver adapted to transmit signals from the one or more output buffers on a plurality of channels;
a processor adapted to repeatedly perform, for each of the channels, at a respective channel cycle, processing sessions in which data for transmission is placed in the one or more output buffers; and
a scheduler adapted to determine occurrence of a starvation state in which the at least one driver began to transmit data from a portion of the buffer before the processor placed data in the buffer portion.

45. A server according to claim 44, wherein the scheduler is adapted to skip or limit one or more processing sessions of one or more of the channels responsive to the determination of the occurrence of a starvation state.

46. A server according to claim 45, wherein the scheduler skips or limits one or more processing sessions of one or more channels which were affected by the starvation state.

47. A server according to claim 45, wherein the scheduler skips or limits one or more processing sessions of one or more channels which were not affected by the starvation state.

48. A method of scheduling a processor of a remote access server, which server includes at least one driver adapted to transmit signals from one or more output buffers on a plurality of channels, comprising:
scheduling a processor to perform a processing session in which data is placed in a specific location in the one or more output buffers; and
determining whether a starvation state occurred in which the at least one driver began to transmit data from the specific location before the processor completed the processing session.

49. A method according to claim 48, comprising instructing the processor to skip or limit one or more processing sessions of one or more of the channels responsive to determination of the occurrence of a starvation state.

50. A connection handling server, comprising:
one or more output buffers;
at least one driver adapted to transmit signals from one or more output buffers on a plurality of channels;
a processor adapted to repeatedly perform, for each of the channels, during a common cycle, processing sessions in which data for transmission is placed in the one or more output buffers,
wherein the processor begins the processing of at least some of the common cycles before the at least one driver begins to transfer the data prepared during the previous common cycle.

51. A server according to claim 50, wherein the processor begins the processing of at least some of the common cycles at least 1 ms before the at least one driver begins to transfer the data prepared during the previous common cycle.

52. A method for preparing data for transmission by at least one driver adapted to transmit signals from one or more output buffers, comprising:
placing data in the one or more output buffers for each of a plurality of channels, during a first cycle; and
beginning to place data in the one or more output buffers for at least one of the plurality of channels in a second cycle, before the at least one driver began to transmit data placed in the one or more output buffers during the first cycle.
